(19) United States
(12) Patent Application Publication
(10) Pub. No.: US 2025/0031068 A1
(43) Pub. Date: Jan. 23, 2025

(54) MECHANISM FOR FUNCTIONALITY BASED LIFE CYCLE MANAGEMENT

(71) Applicant: Nokia Technologies Oy, Espoo (FI)

(72) Inventors: Amir Mehdi AHMADIAN TEHRANI, Munich (DE); Andrea BONFANTE, Paris (FR); Keeth Saliya Jayasinghe LADDU, Espoo (FI); Frederick VOOK, Schaumburg, IL (US); Tachporn SANGUANPUAK, Oulu (FI)

(21) Appl. No.: 18/777,062

(22) Filed: Jul. 18, 2024

Related U.S. Application Data
(60) Provisional application No. 63/514,714, filed on Jul. 20, 2023.

(51) Int. Cl. H04W 24/02; H04W 16/28; H04W 64/00

(52) U.S. Cl. CPC H04W 24/02; H04W 16/28; H04W 64/00

(57) ABSTRACT

The present disclosure relates to a solution for functionality-based performance monitoring. In particular, a solution is proposed to enable functionality-based performance monitoring via sending updates on the configured/identified functionalities using applicable conditions framework. In this way, it can improve performance of the AI/ML entity.

### FIELDS

Various example embodiments of the present disclosure generally relate to the field of telecommunication and in particular, to methods, devices, apparatuses and computer readable storage medium for functionality based life cycle management (LCM).

### BACKGROUND

Artificial Intelligence (AI) and Machine Learning (ML) techniques are being increasingly employed in 5G system (5GS) and are considered as a key enabler of 5G-Advanced and 6G mobile network generation. In the telecommunication industry, AI/ML models have been employed in telecommunication systems to improve the performance of telecommunications systems. AI/ML techniques can be adopted in a plurality of scenarios.

Therefore, it is worth to further study AI/ML techniques.

### SUMMARY

In a first aspect of the present disclosure, there is provided an apparatus. The apparatus comprises at least one processor; and at least one memory storing instructions that, when executed by the at least one processor, cause the apparatus to: transmit, to a network device, first information indicating at least one artificial intelligence and machine learning (AI/ML) entity supported by the apparatus and a delay associated with the at least one AI/ML entity, wherein the delay comprises at least one of: an activation delay of the at least one AI/ML entity, or a switching delay between another AI/ML entity and the at least one AI/ML entity; determine an updated delay associated with the at least one AI/ML entity, wherein the updated delay comprises at least one of: an updated activation delay of the at least one AI/ML entity, or an updated switching delay between the other AI/ML entity and the at least one AI/ML entity; and transmit, to the network device, second information associated with the updated delay.

In a second aspect of the present disclosure, there is provided an apparatus. The apparatus comprises at least one processor; and at least one memory storing instructions that, when executed by the at least one processor, cause the apparatus to: receive, from a terminal device, first information indicating a condition associated with configuring at least one AI/ML entity and a delay associated with the at least one AI/ML entity, wherein the delay at least one of: an activation delay of the at least one AI/ML entity, or a switching delay between another AI/ML entity to the at least one AI/ML entity; and receive, from the terminal device, second information associated with an updated delay associated with the at least one AI/ML entity, wherein the updated delay comprises at least one of: an updated activation delay of the at least one AI/ML entity, or an updated switching delay between the other AI/ML entity and the at least one AI/ML entity.

In a third aspect of the present disclosure, there is provided a method. The method comprises: transmitting, to a network device, first information indicating at least one artificial intelligence and machine learning (AI/ML) entity supported by the apparatus and a delay associated with the at least one AI/ML entity, wherein the delay comprises at least one of: an activation delay of the at least one AI/ML entity, or a switching delay between another AI/ML entity and the at least one AI/ML entity; determining an updated delay associated with the at least one AI/ML entity, wherein the updated delay comprises at least one of: an updated activation delay of the at least one AI/ML entity, or an updated switching delay between the other AI/ML entity and the at least one AI/ML entity; and transmitting, to the network device, second information associated with the updated delay.

In a fourth aspect of the present disclosure, there is provided a method. The method comprises: receiving, from a terminal device, first information indicating a condition associated with configuring at least one AI/ML entity and a delay associated with the at least one AI/ML entity, wherein the delay at least one of: an activation delay of the at least one AI/ML entity, or a switching delay between another AI/ML entity to the at least one AI/ML entity; and receiving, from the terminal device, second information associated with an updated delay associated with the at least one AI/ML entity, wherein the updated delay comprises at least one of: an updated activation delay of the at least one AI/ML entity, or an updated switching delay between the other AI/ML entity and the at least one AI/ML entity.

In a fifth aspect of the present disclosure, there is provided a first apparatus. The first apparatus comprises means for transmitting, to a network device, first information indicating at least one artificial intelligence and machine learning (AI/ML) entity supported by the apparatus and a delay associated with the at least one AI/ML entity, wherein the delay comprises at least one of: an activation delay of the at least one AI/ML entity, or a switching delay between another AI/ML entity and the at least one AI/ML entity; means for determining an updated delay associated with the at least one AI/ML entity, wherein the updated delay comprises at least one of: an updated activation delay of the at least one AI/ML entity, or an updated switching delay between the other AI/ML entity and the at least one AI/ML entity; and means for transmitting, to the network device, second information associated with the updated delay.

In a sixth aspect of the present disclosure, there is provided a second apparatus. The second apparatus comprises means for receiving, from a terminal device, first information indicating a condition associated with configuring at least one AI/ML entity and a delay associated with the at least one AI/ML entity, wherein the delay at least one of: an activation delay of the at least one AI/ML entity, or a switching delay between another AI/ML entity to the at least one AI/ML entity; and means for receiving, from the terminal device, second information associated with an updated delay associated with the at least one AI/ML entity, wherein the updated delay comprises at least one of: an updated activation delay of the at least one AI/ML entity, or an updated switching delay between the other AI/ML entity and the at least one AI/ML entity.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for performance monitoring on functionality according to example embodiments of the present disclosure;

FIG. 3 illustrates a schematic diagram of functionality switching according to example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The term “AI/ML model” used herein may refer to a data driven algorithm that applies AI/ML techniques to generate a set of outputs based on a set of inputs. The terms “AI/ML model” and “model” may be used interchangeable. The term “functionality” used herein may refer to an AI/ML-enabled Feature/FG enabled by configuration(s), where configuration(s) is(are) supported based on conditions indicated by UE capability. The term “AI/ML entity” used herein may refer to an AI/ML model or a functionality.

The term “UE-side (AI/ML) model” used herein may refer to an AI/ML Model of which inference is performed entirely at the UE. The term “network-side (AI/ML) model” used herein may refer to an AI/ML Model of which inference is performed entirely at the network. The term “one-side (AI/ML) model” used herein may refer to a UE-side (AI/ML) model or a network-side (AI/ML) model. The term “two Two-sided (AI/ML) model” used herein may refer to a paired AI/ML Model(s) over which joint inference is performed, where joint inference includes AI/ML Inference whose inference is performed jointly across the UE and the network, i.e, the first part of inference is firstly performed by UE and then the remaining part is performed by gNB, or vice versa.

The term “activation” used herein may refer to enabling an AI/ML entity for a specific function. The term “deactivation” used herein may refer to disabling an AI/ML entity for a specific function. The term “switching” used herein may refer to deactivating a currently active AI/ML entity and activating a different AI/ML entity for a specific function. The term “model management” used herein may refer to a more general term includes one or more of following functions/procedures: model activation, deactivation, selection, switching, fallback, and update (including re-training).

As mentioned above, AI/ML techniques can be adopted in a plurality of scenarios. For example, the set of use cases of AI/ML techniques may include channel state information (CSI) feedback enhancement, a beam management, and a positioning accuracy enhancement.

In some solutions, there is a set of operations for supporting beamforming transmission, including beam sweeping, beam measurements and reporting, beam maintenance and recovery. All these aspects are detailed in the standard under the broad topic of beam management procedures. Beam management has evolved to support more advanced configurations such as multi beams reporting to enable multi transmission reception points (TRPs) and multi-panel configurations. However, the fundamental problem of the beam management procedures is that with a larger number of beams supported by high-dimensional multi-input-multi-output (MIMO) arrays, the CSI-reference signal (RS) measurements and feedback overhead radically increase to enable beam selection. In addition, the time required for gNB and UE to complete the beam sweeping and establish the best beam increases accordingly. Thus, limiting the support of low latency communication. This is mainly due to the frequency of synchronization signal block (SSB)/CSI-RS transmission during procedures P1, P2, P3 that are described in 3GPP TR 38.802 and summarized as follows:
P1 provides beam sweeping implemented for the gNB to scan the coverage area periodically transmitting SSBs with wide angular beams. Conversely, the UE scans different SSBs to identify the best beam and corresponding time/frequency resources on which requesting access.
During P2, the gNB performs beam refinement transmitting CSI-RSs with narrow beams to identify a more precise direction towards the UE after establishing the wide beam in P1.
During P3, beam refinement is implemented at the UE side to scan a set of Rx narrow beams while the gNB transmits CSI-RSs using the best beam identified in P2.

The procedures P1, P2 and P3, are executed sequentially to establish the data transmission between gNB and UE, and in case of beam failure and recovery are fully repeated. In addition, P2 and P3 are also periodically repeated for beam maintenance.

Supporting AI/ML-based beam management can save overhead and reduce latency. It has been shown that ML algorithms enable predicting the serving beam for different UE locations and time instances, thus avoiding measuring the actual beam quality and saving those resources to be employed for data transmission. On the other hand, beam scanning operations like those performed in P1, P2 and P3 are time inefficient and not scalable when the size of antenna arrays increases. Therefore, ML algorithms can replace sequential beam scanning by recommending a reduced set of beams likely to contain the best beam index of the full scan.

Further, for AI/ML functionality identification and functionality-based life cycle management (LCM) of UE-side models and/or UE-part of two-sided models, functionality-based LCM operates based on, at least, one configuration of AI/ML-enabled Feature/FG or specific configurations of an AI/ML-enabled Feature/FG. For AI/ML model identification and model-ID-based LCM of UE-side models and/or UE-part of two-sided models, model-ID-based LCM operates based on identified models, where a model as well as functionality-based LCM may be associated with specific configurations/conditions associated with UE capability of an AI/ML-enabled Feature/FG and additional conditions (e.g., scenarios, sites, and datasets) as determined/identified between UE-side and NW-side. As it can be seen, functionality definition, configuration and for AI/ML functionality identification and functionality-based LCM of UE-side models has been investigated. One main aspect is to define the conditions and content on activate/switch/deactivate/fallback AI/ML functionalities.

Functionality-based LCM operations has been identified as one of the potential solutions towards identifying and studying conditions to enable development of supported functionality/functionalities of a given use case ML enabled feature. In functionality identification and functionality-based LCM, knowing the UE conditions (including parameters/configurations) is required at the network as the first step before any other, as this shall reveal the background conditions when using ML models for supporting a given ML-enabled feature.

In a solution, the UE may report the worse-case switching/activation delay for all functionalities as the UE may not know the exact functionality configuration(s) coming from the network, and UE may report that to be the same delay for all possible functionalities (configurations) as it may sound feasible approach with legacy-like UE capability reporting. However, this solution may not reveal actual delays in switching/activating a functionality and may cause large delays when switching among functionalities.

In another solution, the UE may report to the NW, still via capability report, different switching/activation delays which may be corresponding to different functionalities. But the UE capability signaling may need significant changes as UE has to refer to some sort of “identified functionality” (a configurable functionality based on reported conditions of the UE capability) prior to receiving any functionality configuration. With such an approach, the UE may be able to define some association of different delay values with the identified functionalities. This will be a challenging task due to significant changes to the legacy capability signaling framework to support that. Assuming this can be done, it is still hard to report the actual delays for functionality activation/switching as delays for switching/activating a functionality may vary over time.

Although UE capability report is used to report switching delays among functionalities is known, it has not investigated identifying dynamic switching/activation among multiple functionalities where indication of LCM operations with respect to performance monitoring for multiple functionalities with different activation/switching delays can be investigated. Moreover, reporting updates on applicable functionalities (with different applicable conditions e.g., activation delays) has not been studied yet in functionality-based LCM operations.

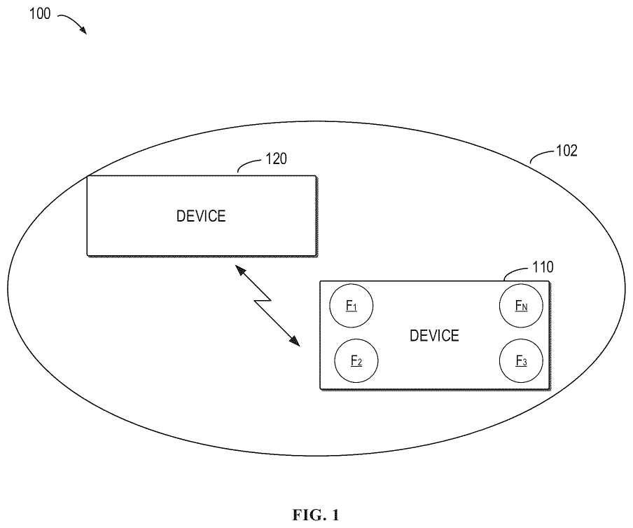

FIG. 1 illustrates an example communication environment 100 in which example embodiments of the present disclosure can be implemented. In the communication environment 100, a plurality of communication devices, including a first device 110 and a second device 120, can communicate with each other. It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. The first device 110 may support one or more AI/ML entities, for example, the AI/ML entities F₁, F₂, F₃, . . . F_{N}, where N is an integer number. The one or more AI/ML entities may include one or more AI/ML model. Alternatively, the one or more AI/ML entities may include one or more functionalities. The AI/ML entity may be adopted in channel state information feedback. Alternatively, or in addition, the AI/ML entity may be adopted in beam management. In some other example embodiments, the AI/ML entity may be adopted in positioning.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), and a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

According to some example embodiments of the present disclosure, there is provided a solution for functionality-based performance monitoring. In particular, a solution is proposed to enable functionality-based performance monitoring via sending updates on the configured/identified functionalities using applicable conditions framework. In this way, it can improve performance of the AI/ML entity.

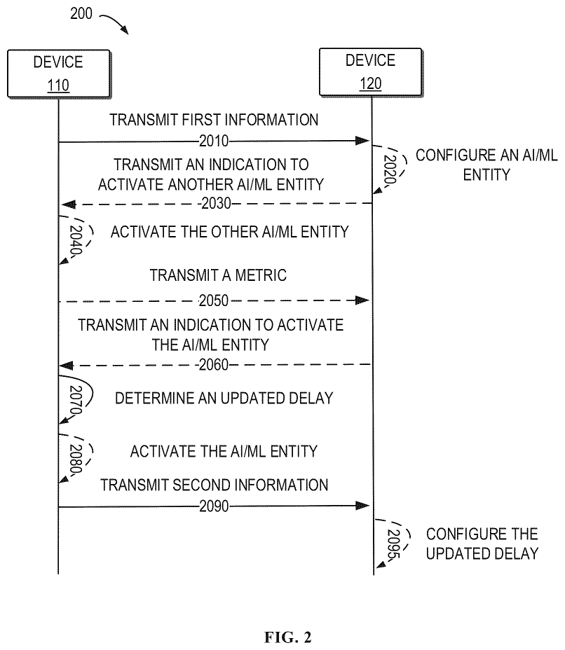

Example embodiments of the present disclosure will be described in detail below with reference to the accompanying drawings. Reference is now made to FIG. 2, which illustrates a signaling flow 200 for the reference signal transmission alignment according to some example embodiments of the present disclosure. For the purposes of discussion, the signaling flow 200 will be discussed with reference to FIG. 1, for example, by using the first device 110 and the second device 120.

The first device 110 transmits (2010) first information to the second device 120. In other words, the second device 120 receives the first information from the first device 110. The first information may be transmitted using UE capability signaling.

The first information indicates an AI/ML entity (for example, one or more of the AI/ML entities F₁, F₂, F₃, . . . F_{N}) supported by the apparatus. In an example embodiment, the first information may include the number of supported AI/ML entities. For example, if the first device 110 supports the AI/ML entities F₁, F₂, F₃, . . . F_{N}, the number of supported AI/ML entities included in the first information may be “N.”

The first information further includes a delay associated with the AI/ML entity. The delay may include an activation delay of the AI/ML entity. In an example embodiment, the activation delay may be common for all AI/ML entity. For example, if the first device 110 supports the AI/ML entities F₁, F₂, F₃, the first information may include a maximum activation delay that is common to the AI/ML entities F₁, F₂, F₃. In another example, the first information may include the activation delay of each AI/ML entity. For example, if the first device 110 supports the AI/ML entities F₁, F₂, F₃, the first information may include the activation delay of the AI/ML entity F₁, the activation delay of the AI/ML entity F₂ and the activation delay of the AI/ML entity F₃.

Alternatively, or in addition, the delay may include a switching delay between another AI/ML entity and the AI/ML entity. In an example embodiment, the switching delay may be common for all AI/ML entity. For example, if the first device 110 supports the AI/ML entities F₁, F₂, F₃, the first information may include a maximum switching delay that is common to switching among the AI/ML entities F₁, F₂, F₃. In another example, the first information may include the switching delay between each two AI/ML entities. By way of example, the first information may include a maximum switching delay between each two AI/ML entities. For example, if the first device 110 supports the AI/ML entities F₁, F₂, F₃, the first information may include the switching delay between the AI/ML entities F₁ and F₂, the switching delay between the AI/ML entities F₂ and F₃, and the switching delay between the AI/ML entities F₃ and F₁.

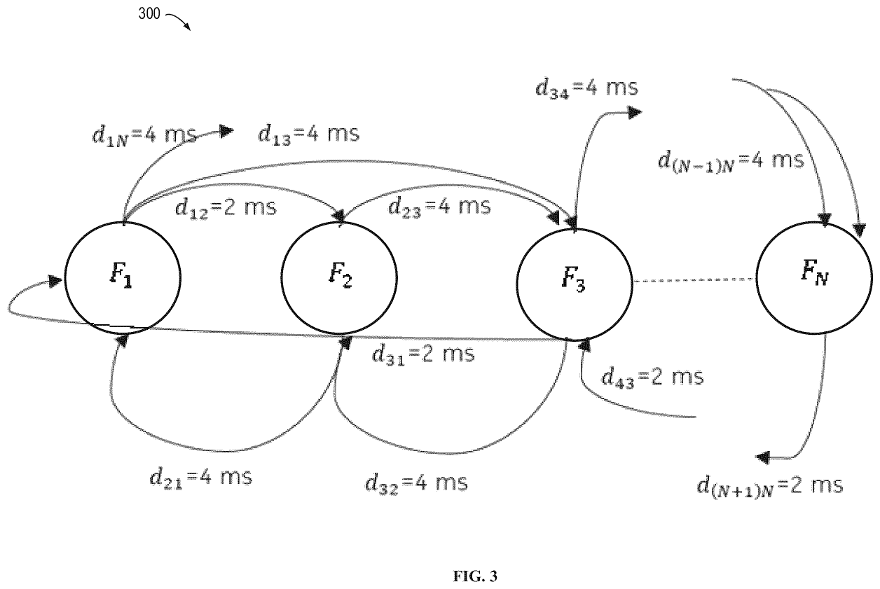

FIG. 3 illustrates a schematic diagram of functionality switching 300 according to example embodiments of the present disclosure. By way of example, the first information may include conditions associated with configuring {F₁, F₂, F₃, . . . F_{N}} as shown in FIG. 3 and corresponding maximum switching delays (e.g., d_{maxFij}, where Fᵢⱼ represents switching from the AI/ML entity Fⱼ to the AI/ML entity Fⱼ. In an example, the first information may include corresponding maximum switching or activation delays of supported BM use case AI/ML entities {F₁, F₂, F₃, . . . F_{N}} as shown in Table 1 below. It is noted that Table 1 is only an example not limitation.

TABLE 1

| Switching transition (Fᵢⱼ) | Maximum Switching Delay (d_{max Fij}) |
|---|---|
| F₁₁ | d_{max F11} |
| F₁₂ | d_{max F12} |
| . . . | . . . |
| F_{(N + 1)N} | d_{max F(N + 1)N} |

In some example embodiments, the AI/ML entities {F₁, F₂, F₃, . . . F_{N}} may be as below Table 2. It is noted that Table 2 is only an example not limitation.

TABLE 2

| Functionality | Description |
|---|---|
| F₁ | DL Tx Beam prediction |
| F₂ | Tx - RX Beam pair prediction |
| . . . | . . . |
| F_{N} | Rx Beam prediction |

In some example embodiments, the first information may also include applicable conditions for AJ/ML entities associated with the beam management (BM)-Case1 assuming DL TX beam prediction listed in Table 3 below.

TABLE 3
Support Top-K DL Tx beam prediction
K = 1, 2, 4, [8]
This defines the support of predicting best-K NZP CSI-RS resources based
on SSB and/or CSI-RS-based RSRP measurements.
Set B conditions
Measured DL RS (SSB, CSI-RS)
Defines support of using SSB and/or CSI-RS-based RSRP measurements.
Measured DL RS set dimension (4, 8, 12, [16])
Indicates the minimum number of NZP-CSI-RS resources that shall be
measured and used by the UE for predicting best-K NZP CSI-RS resources
Measured DL RS set pattern (e.g., fixed, pre-configured list, random)
Indicates the limitations on Set B conditions
Set A conditions
Predicted DL RS (CSI-RS)
Defines support of predicting CSI-RS resources
Predicted DL RS set dimension (16, 32, 64)
Indicates the maximum number of NZP-CSI-RS resources that shall be
configured as the prediction NZP-CSI-RS resource set
NW-side performance monitoring conditions
Support measurements of Predicted DL RS set (full Set A, partial Set A)
Defines the support of measuring the NZP-CSI-RS resources that
correspond to Set A.
Measurement periodicity (100 ms, 200 ms)
Indicates the minimum periodicity when supporting NZP-CSI-RS
resources that correspond to Set A.
Conditions on supporting ML functionalities
Max number of supported functionalities (1, 2, 4, 8,)
Indicates the maximum number of functionalities (e.g., number of
parameter combinations that enable ML-enabled feature) that can be
configured toward the UE
Delay in activating a functionality (2 ms, 4 ms,.)
Indicates the delay required when activating or switching a
functionality
Generalization condition of functionalities (yes, no)
Indicates that the UE supports any functionality configured considering
the parameter combinations of 1-4 and can be used towards the UE
without any validation of whether the functionality is applicable or not.

In some example embodiments, the first information may also include applicable conditions for AJ/ML entities associated with the BM-Case2 assuming DL Tx beam prediction, support Top-K DL Tx beam prediction listed as in Table 4 below.

TABLE 4

K = 1, 2, 4, [8]
This defines the support of predicting best-K NZP CSI-RS resources based
on SSB and/or CSI-RS-based RSRP measurements.
Set B conditions
Measured DL RS (SSB, CSI-RS)
Defines support of using SSB and/or CSI-RS-based RSRP measurements.
Measured DL RS set dimension (4, 8, 12, [16])
Indicates the minimum number of NZP-CSI-RS resources that shall be
measured and used by the UE for predicting best-K NZP CSI-RS resources
Measured DL RS set periodicity (40 ms, 80 ms)
Indicates the minimum time duration for measuring NZP-CSI-RS resources
that shall be measured.
Measured DL RS set pattern (e.g., fixed, pre-configured list, random)
Indicates the limitations on Set B conditions
Set A conditions
Predicted DL RS (CSI-RS)
Defines support of predicting CSI-RS resources
Predicted DL RS set dimension (12, 16, 32, 64)
Indicates the maximum number of NZP-CSI-RS resources that shall be
configured as the prediction NZP-CSI-RS resource set
Predicted DL RS set - number of future instances (40 ms, 80 ms)
Indicates the maximum time duration (or the number of future instances
compared to measurement periodicity) that the NZP-CSI-RS resources can
be predicted based on Set B.
NW-side performance monitoring conditions
Support measurements of Predicted DL RS set (full Set A, partial Set A)
Defines the support of measuring the NZP-CSI-RS resources that correspond
to Set A.
Measurement periodicity (100 ms, 200 ms)
Indicates the minimum periodicity when supporting NZP-CSI-RS resources
that correspond to Set A.
Conditions on supporting ML functionalities
Max number of supported functionalities (1, 2, 4, 8,)
Indicates the maximum number of functionalities (e.g., number of parameter
combinations that enable ML-enabled feature) that can be configured toward
the UE
Delay in activating a functionality (2 ms, 4 ms,.)
Indicates the delay required when activating or switching a functionality
Generalization condition of functionalities (yes, no)
Indicates that the UE supports any functionality configured considering the
parameter combinations of 1-4 and can be used towards the UE without any
validation of whether the functionality is applicable or not.

The second device 120 may configure (2020) one or more AI/ML entities based on the first information. For example, the second device 120 may configure the AI/ML entities {F₁, F₂, F₃, . . . F_{N}}. The second device 120 may also obtain the delay from the first information. For example, the second device 120 may determine corresponding initial configured switching delays (e.g., d_{maxFij}) with respect to supported AI/ML entities indicated via UE capability signaling.

The second device 120 may transmit (2030) an indication to activate another AI/ML entity to the first device 110. In other words, the first device 110 may receive the indication to activate another AI/ML entity from the second device 120. For example, the second device 120 may indicate the first device 110 to activate the AI/ML entity Fᵢ via an LCM operation. The first device 110 may activate (2040) the other functionality, for example, the AI/ML entity Fᵢ. In some embodiments, contributing factor for activation delay of an AI/ML entity or switching delay between two AI/ML entities may involve model inference delay corresponding, setting up or downloading a model, pre-processing delay due to the measurements, or logical model complexities (e.g., in terms of difference on parameter updates or structure updates) which may impact periodic measurement and reporting.

The first device 110 may transmit (2050) a metric obtained by the first device 110 to the second device 120. In other words, the second device 120 may receive the metric from the first device 110. For example, the first device 110 may perform a measurement and transmit the measurement to the second device 120. By way example, the metric may be measured reference signal received power (L1-RSRP).

The second device 120 may transmit (2060) an indication to activate the AI/ML entity to the first device 110. In other words, the first device 110 may receive the indication to activate the AI/ML entity from the second device 120. For example, the second device 120 may indicate the first device 110 to activate the AI/ML entity Fⱼ via the LCM operation.

The second device 120 may expect the corresponding delay to be the delay indicted in the first information. For example, the second device 120 may expect the switching delay from AI/ML entity Fᵢ to AI/ML entity Fⱼ to be d_{maxFij}.

The first device 110 determines (2070) an updated delay associated with the AI/ML entity. The updated delay may include an updated activation delay of the AI/ML entity. Alternatively, or in addition, the updated delay may include an updated switching delay between the other AI/ML entity and the AI/ML entity. For example, if the indication is received (2060) from the second device 120, the first device 110 may determine the updated delay. By way of example, after the reporting of the first information to the second device 120, the first device 110 may determine a change in a value of activation delay of Fⱼ or a change value of switching delay from AI/ML entity Fᵢ to AI/ML entity Fⱼ for future reporting instances. The first device 110 may activate (2080) the AI/ML entity. For example, the first device 110 may switch from AI/ML entity Fᵢ to AI/ML entity Fⱼ.

The first device 110 transmits (2090) second information associated with the updated delay to the second device 120. In other words, the second device 120 receives the second information associated with the updated delay from the first device 110. For example, the second information may include an indication to change the previously reported (2010) delay. In some example embodiments, the transmission of the second information may be applied based on a UE event triggered reporting mechanism. In this way, the actual delay can be reported to the network, thereby improving the performance of the AI/ML entity.

In an example embodiment, the first device 110 may determine whether there is a change between the delay and the updated delay based on a predefined criterion. For example, the predefined criterion may be predefined or preconfigured at the first device 110. In this case, the first device 110 may transmit the second information associated with the updated delay based on the changed.

In an example embodiment, if the updated activation delay is smaller than or equal to a first threshold delay, the first device 110 may determine that there is the change between the delay and the updated delay based on the predefined criterion. In this case, the second information may indicate the first threshold or the updated activation delay. The first threshold delay may be the activation delay multiplying a first scaling factor. In an example embodiment, the first scaling factor may be configured by the second device 120. In another example embodiment, if the updated activation delay is larger than the first threshold delay but smaller or equal to the activation delay, the first device 110 may determine that there is no change between the delay and the updated delay based on the predefined criterion. In this case, the second information may indicate no change between the delay and the updated delay.

In a yet example embodiment, if the updated activation delay is larger than the activation delay but smaller or equal to a second threshold delay, the first device 110 may determine that there is the change between the delay and the updated delay based on the predefined criterion. In this case, the second information may indicate the second threshold delay or the updated activation delay. The second threshold delay may be the activation delay multiplying a second scaling factor which may be configured by the second device 120. In a further example embodiment, if the updated activation delay is larger than a second threshold delay, the first device 110 determine that the updated activation is out of range based on the predefined criterion. In this case, the second information may indicate no support of the AI/ML entity.

In an example embodiment, if the updated switching delay is smaller than or equal to a third threshold delay, the first device 110 may determine that there is the change between the delay and the updated delay based on the predefined criterion. In this case, the second information may indicate the third threshold delay or the updated switching delay. The third threshold delay may be the switching delay multiplying a third scaling factor. In an example embodiment, the third scaling factor may be configured by the second device 120. For example, assuming d_{F}_{ᵢⱼ} denotes the updated delay corresponding to activation/switching from AI/ML entity Fᵢ to AI/ML entity Fⱼ and d_{maxFij} denotes the report (2010) delay corresponding to activation/switching from AI/ML entity F1 to AI/ML entity Fⱼ, and L1 and L2 (0<L1 (indicating lower delays)<=1 and/or 1<L2 (indicating higher delays)), the predefined criterion may include: if d_{F}_{ᵢⱼ}<L1*d_{maxFij}, the first device 110 may report a change (go down to L1) of d_{maxFij}. For future, the second device 120 and/or the first device 110 may assume d_{maxFij}=L1*d_{maxFij}. In this case, if d_{F}_{ᵢⱼ}≤L1*d_{maxFij}, it means that the first device 110 was capable of activation/switching significantly faster from AI/ML entity Fᵢ to AI/ML entity Fⱼ (faster than an L1 fraction of initially configured d_{maxFij}). This could be due to previously experienced models corresponding to Fⱼ while transition from Fᵢ to Fⱼ during inference.

In another example embodiment, if the updated switching delay is larger than the third threshold delay but smaller or equal to the switching delay, the first device 110 may determine there is no change between the delay and the updated delay based on the predefined criterion. In this case, the second information may indicate no change between the delay and the updated delay. For example, the predefined criterion may include: if d_{maxFij}>d_{F}_{ᵢⱼ}>L1*d_{maxFij}, the first device 110 may report no change of d_{maxFij}. In future, the second device 120 and/or the first device 110 may assume d_{maxFij}=d_{maxFij}. In this way, it can bring more flexibility.

In a further example embodiment, if the updated switching delay is larger than the switching delay but smaller or equal to a fourth threshold delay, the first device 110 may determine that there is the change between the delay and the updated delay based on the predefined criterion. In this case, the second information may indicate the fourth threshold delay or the updated switching delay. In an example, the fourth threshold delay may be the switching delay multiplying a fourth scaling factor that may be configured by the second device 120. For example, the predefined criterion may include: if L2*d_{maxFij}≥d_{F}_{ᵢⱼ}>d_{maxFij}, the first device 110 may report a change (go up to L2) of d_{maxFij}. For future, the second device 120 and/or the first device 110 may assume d_{maxFij}=L2*d_{maxFij}. In this case, if L2*d_{maxFij}≥d_{F}_{ᵢⱼ}>d_{maxFij}, it means that the first device 110 is capable of switching from AI/ML entity Fᵢ to AI/ML entity Fⱼ fast enough (higher than d_{maxFij} and less than an L2 fraction of initially configured d_{maxFij}). This could be due to the first experienced models corresponding to Fⱼ while transition from AI/ML entity Fᵢ to AI/ML entity Fⱼ during inference.

In a yet example embodiment, if the updated switching delay is larger than the fourth threshold delay, the first device 110 may determine that the updated switching is out of range based on the predefined criterion. In this case, the second information may indicate no support of the AI/ML entity. For example, the second information may indicate no support of the AI/ML entity Fⱼ.

In some other example embodiments, the second information may also include a metric result obtained by the first device 110. For example, the second information may include L1-RSRP measurements. Alternatively, or in addition, the second information may also include a confirmation message of the activation or the switching of the AI/ML entity. For example, reporting of the updated delay may be done with the confirmation message.

The second device 120 may configure (2095) the updated delay based on the second information. For example, the second device 120 may update the d_{F}_{ᵢⱼ} (instead of d_{maxFij}) for future switching instances of switching from AI/ML entity Fᵢ to AI/ML entity Fⱼ. In an example embodiment, if the second information indicates the updated activation delay, the second device 120 may change the activation delay (for example, d_{maxFij}) of the at least one AI/ML entity to be the updated activation delay (for example, d_{F}_{ᵢⱼ}). In another example embodiment, if the second information indicates the updated switching delay, the second device 120 may change the switching delay of the at least one AI/ML entity to be the updated switching delay. In a yet example embodiment if the second information indicates the first threshold delay, the second device 120 may change the activation delay of the at least one AI/ML entity to be the first threshold delay. In a further example embodiment, if the second information indicates the second threshold delay, the second device 120 may change the activation delay of the at least one AI/ML entity to be the second threshold delay. The second device 120 may change the activation delay of the at least one AI/ML entity to be the third threshold delay, if the second information indicates the third threshold delay. In some other example embodiments, if the second information indicates the fourth threshold delay, the second device 120 may change the switching delay of the at least one AI/ML entity to be the fourth threshold delay.

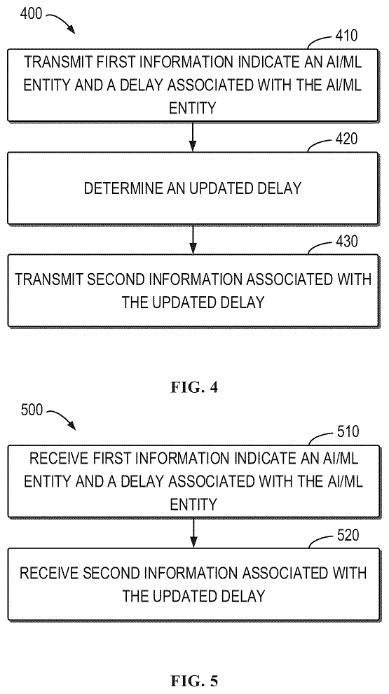

FIG. 4 shows a flowchart of an example method 400 implemented at a first device in accordance with some example embodiments of the present disclosure. For the purpose of discussion, the method 400 will be described from the perspective of the first device 110 in FIG. 1.

At block 410, the apparatus transmits, to a network device, first information indicating at least one artificial intelligence and machine learning (AI/ML) entity supported by the apparatus and a delay associated with the at least one AI/ML entity. The delay comprises at least one of: an activation delay of the at least one AI/ML entity, or a switching delay between another AI/ML entity and the at least one AI/ML entity.

At block 420, the apparatus determines an updated delay associated with the at least one AI/ML entity. The updated delay comprises at least one of: an updated activation delay of the at least one AI/ML entity, or an updated switching delay between the other AI/ML entity and the at least one AI/ML entity.

At block 430, the apparatus transmits, to the network device, second information associated with the updated delay.

In some example embodiments, the method 400 further comprises: in accordance with a determination that an indication to activate or switch to the at least one AI/ML entity is received from the network device, determining the updated delay associated with the at least one AI/ML entity; and switching from the other AI/ML entity to the at least one AI/ML entity.

In some example embodiments, the method 400 further comprises: determining whether there is a change between the delay and the updated delay based on a predefined criterion; and transmitting, to the network device, the second information associated with the updated delay based on the change.

In some example embodiments, the method 400 further comprises: in accordance with a determination that the updated activation delay is smaller than or equal to a first threshold delay, determining that there is the change between the delay and the updated delay based on the predefined criterion, wherein the first threshold delay is the activation delay multiplying a first scaling factor; and transmitting, to the network device, the second information indicating the first threshold delay or the updated activation delay.

In some example embodiments, the method 400 further comprises: in accordance with a determination that the updated activation delay is larger than a first threshold delay but smaller or equal to the activation delay, determining that there is no change between the delay and the updated delay based on the predefined criterion, wherein the first threshold delay is the activation delay multiplying a first scaling factor; and transmitting, to the network device, the second information indicating no change between the delay and the updated delay.

In some example embodiments, the method 400 further comprises: in accordance with a determination that the updated activation delay is larger than the activation delay but smaller or equal to a second threshold delay, determining that there is the change between the delay and the updated delay based on the predefined criterion, wherein the second threshold delay is the activation delay multiplying a second scaling factor; and transmitting, to the network device, the second information indicating the second threshold delay or the updated activation delay.

In some example embodiments, the method 400 further comprises: in accordance with a determination that the updated activation delay is larger than a second threshold delay, determining that the updated activation is out of range based on the predefined criterion, wherein the second threshold delay is the activation delay multiplying a second scaling factor; and transmitting, to the network device, the second information indicating no support of the at least one AI/ML entity.

In some example embodiments, the method 400 further comprises: in accordance with a determination that the updated switching delay is smaller than or equal to a third threshold delay, determining that there is the change between the delay and the updated delay based on the predefined criterion, wherein the third threshold delay is the switching delay multiplying a third scaling factor; and transmitting, to the network device, the second information indicating the third threshold delay or the updated switching delay.

In some example embodiments, the method 400 further comprises: in accordance with a determination that the updated switching delay is larger than a third threshold delay but smaller or equal to the switching delay, determining there is no change between the delay and the updated delay based on the predefined criterion, wherein the first threshold delay is the activation delay multiplying a first scaling factor; and transmitting, to the network device, the second information indicating no change between the delay and the updated delay.

In some example embodiments, the method 400 further comprises: in accordance with a determination that the updated switching delay is larger than the switching delay but smaller or equal to a fourth threshold delay, determining that there is the change between the delay and the updated delay based on the predefined criterion, wherein the fourth threshold delay is the switching delay multiplying a fourth scaling factor; and transmitting, to the network device, the second information indicating the fourth threshold delay or the updated switching delay.

In some example embodiments, the method 400 further comprises: in accordance with a determination that the updated switching delay is larger than a fourth threshold delay, determining that the updated switching is out of range based on the predefined criterion, wherein the fourth threshold delay is the switching delay multiplying a fourth scaling factor; and transmitting, to the network device, the second information indicating that no support of the at least one AI/ML entity.

In some example embodiments, the second information further comprises a metric result obtained by the apparatus.

In some example embodiments, the at least one AI/ML entity is related to one of: channel state information feedback of the apparatus, a beam management of the apparatus, or a positioning of the apparatus.

FIG. 5 shows a flowchart of an example method 500 implemented at a second device in accordance with some example embodiments of the present disclosure. For the purpose of discussion, the method 500 will be described from the perspective of the second device 120 in FIG. 1.

At block 510, the apparatus receives, from a terminal device, first information indicating a condition associated with configuring at least one AI/ML entity and a delay associated with the at least one AI/ML entity. The delay comprises at least one of: an activation delay of the at least one AI/ML entity, or a switching delay between another AI/ML entity to the at least one AI/ML entity.

At block 520, the apparatus receives, from the terminal device, second information associated with an updated delay associated with the at least one AI/ML entity. The updated delay comprises at least one of: an updated activation delay of the at least one AI/ML entity, or an updated switching delay between the other AI/ML entity and the at least one AI/ML entity.

In some example embodiments, the method 500 further comprises: in accordance with a determination that the second information indicates the updated activation delay, changing the activation delay of the at least one AI/ML entity to be the updated activation delay.

In some example embodiments, the method 500 further comprises: in accordance with a determination that the second information indicates the updated switching delay, changing the switching delay of the at least one AI/ML entity to be the updated switching delay.

In some example embodiments, the method 500 further comprises: in accordance with a determination that the second information indicates a first threshold delay that is the activation delay multiplying a first scaling factor, changing the activation delay of the at least one AI/ML entity to be the first threshold delay.

In some example embodiments, the method 500 further comprises: in accordance with a determination that the second information indicates a second threshold delay that is the activation delay multiplying a second scaling factor, changing the activation delay of the at least one AI/ML entity to be the second threshold delay.

In some example embodiments, the method 500 further comprises: in accordance with a determination that the second information indicates a third threshold delay that is the switching delay multiplying a third scaling factor, changing the switching delay of the at least one AI/ML entity to be the third threshold delay.

In some example embodiments, the method 500 further comprises: in accordance with a determination that the second information indicates a fourth threshold delay that is the switching delay multiplying a fourth scaling factor, changing the switching delay of the at least one AI/ML entity to be the fourth threshold delay.

In some example embodiments, the second information indicates no support of the at least one AI/ML entity.

In some example embodiments, the second information further comprises a metric obtained by the terminal device/ML entity.

In some example embodiments, the at least one AI/ML entity is related to one of: channel state information feedback of the terminal device, a beam management of the terminal device, or a positioning of the terminal device.

In some example embodiments, a first apparatus capable of performing any of the method 400 (for example, the first device 110 in FIG. 1) may comprise means for performing the respective operations of the method 400. The means may be implemented in any suitable form. For example, the means may be implemented in a circuitry or software module. The first apparatus may be implemented as or included in the first device 110 in FIG. 1.

In some example embodiments, the first apparatus comprises means for transmitting, to a network device, first information indicating at least one artificial intelligence and machine learning (AI/ML) entity supported by the apparatus and a delay associated with the at least one AI/ML entity, wherein the delay comprises at least one of: an activation delay of the at least one AI/ML entity, or a switching delay between another AI/ML entity and the at least one AI/ML entity; means for determining an updated delay associated with the at least one AI/ML entity, wherein the updated delay comprises at least one of: an updated activation delay of the at least one AI/ML entity, or an updated switching delay between the other AI/ML entity and the at least one AI/ML entity; and means for transmitting, to the network device, second information associated with the updated delay.

In some example embodiments, the first apparatus further comprises: means for in accordance with a determination that an indication to activate or switch to the at least one AI/ML entity is received from the network device, determining the updated delay associated with the at least one AI/ML entity; and means for switching from the other AI/ML entity to the at least one AI/ML entity.

In some example embodiments, the first apparatus further comprises: means for determining whether there is a change between the delay and the updated delay based on a predefined criterion; and means for transmitting, to the network device, the second information associated with the updated delay based on the change.

In some example embodiments, the first apparatus further comprises: means for in accordance with a determination that the updated activation delay is smaller than or equal to a first threshold delay, determining that there is the change between the delay and the updated delay based on the predefined criterion, wherein the first threshold delay is the activation delay multiplying a first scaling factor; and means for transmitting, to the network device, the second information indicating the first threshold delay or the updated activation delay.

In some example embodiments, the first apparatus further comprises: means for in accordance with a determination that the updated activation delay is larger than a first threshold delay but smaller or equal to the activation delay, determining that there is no change between the delay and the updated delay based on the predefined criterion, wherein the first threshold delay is the activation delay multiplying a first scaling factor; and means for transmitting, to the network device, the second information indicating no change between the delay and the updated delay.

In some example embodiments, the first apparatus further comprises: means for in accordance with a determination that the updated activation delay is larger than the activation delay but smaller or equal to a second threshold delay, determining that there is the change between the delay and the updated delay based on the predefined criterion, wherein the second threshold delay is the activation delay multiplying a second scaling factor; and means for transmitting, to the network device, the second information indicating the second threshold delay or the updated activation delay.

In some example embodiments, the first apparatus further comprises: means for in accordance with a determination that the updated activation delay is larger than a second threshold delay, determining that the updated activation is out of range based on the predefined criterion, wherein the second threshold delay is the activation delay multiplying a second scaling factor; and means for transmitting, to the network device, the second information indicating no support of the at least one AI/ML entity.

In some example embodiments, the first apparatus further comprises: means for in accordance with a determination that the updated switching delay is smaller than or equal to a third threshold delay, determining that there is the change between the delay and the updated delay based on the predefined criterion, wherein the third threshold delay is the switching delay multiplying a third scaling factor; and means for transmitting, to the network device, the second information indicating the third threshold delay or the updated switching delay.

In some example embodiments, the first apparatus further comprises: means for in accordance with a determination that the updated switching delay is larger than a third threshold delay but smaller or equal to the switching delay, determining there is no change between the delay and the updated delay based on the predefined criterion, wherein the first threshold delay is the activation delay multiplying a first scaling factor; and means for transmitting, to the network device, the second information indicating no change between the delay and the updated delay.

In some example embodiments, the first apparatus further comprises: means for in accordance with a determination that the updated switching delay is larger than the switching delay but smaller or equal to a fourth threshold delay, determining that there is the change between the delay and the updated delay based on the predefined criterion, wherein the fourth threshold delay is the switching delay multiplying a fourth scaling factor; and means for transmitting, to the network device, the second information indicating the fourth threshold delay or the updated switching delay.

In some example embodiments, the first apparatus further comprises: means for in accordance with a determination that the updated switching delay is larger than a fourth threshold delay, determining that the updated switching is out of range based on the predefined criterion, wherein the fourth threshold delay is the switching delay multiplying a fourth scaling factor; and means for transmitting, to the network device, the second information indicating no support of the at least one AI/ML entity.

In some example embodiments, the second information further comprises a metric result obtain by the apparatus.

In some example embodiments, the at least one AI/ML entity is related to one of: channel state information feedback of the apparatus, a beam management of the apparatus, or a positioning of the apparatus.

In some example embodiments, the apparatus comprises a terminal device.

In some example embodiments, the first apparatus further comprises means for performing other operations in some example embodiments of the method 400 or the first device 110. In some example embodiments, the means comprises at least one processor; and at least one memory storing instructions that, when executed by the at least one processor, cause the performance of the first apparatus.

In some example embodiments, a second apparatus capable of performing any of the method 500 (for example, the second device 120 in FIG. 1) may comprise means for performing the respective operations of the method 500. The means may be implemented in any suitable form. For example, the means may be implemented in a circuitry or software module. The second apparatus may be implemented as or included in the second device 120 in FIG. 1.

In some example embodiments, the second apparatus comprises means for receiving, from a terminal device, first information indicating a condition associated with configuring at least one AI/ML entity and a delay associated with the at least one AI/ML entity, wherein the delay at least one of: an activation delay of the at least one AI/ML entity, or a switching delay between another AI/ML entity to the at least one AI/ML entity; and means for receiving, from the terminal device, second information associated with an updated delay associated with the at least one AI/ML entity, wherein the updated delay comprises at least one of: an updated activation delay of the at least one AI/ML entity, or an updated switching delay between the other AI/ML entity and the at least one AI/ML entity.

In some example embodiments, the second apparatus further comprises: means for in accordance with a determination that the second information indicates the updated activation delay, changing the activation delay of the at least one AI/ML entity to be the updated activation delay.

In some example embodiments, the second apparatus further comprises: means for in accordance with a determination that the second information indicates the updated switching delay, changing the switching delay of the at least one AI/ML entity to be the updated switching delay.

In some example embodiments, the second apparatus further comprises: means for in accordance with a determination that the second information indicates a first threshold delay that is the activation delay multiplying a first scaling factor, changing the activation delay of the at least one AI/ML entity to be the first threshold delay.

In some example embodiments, the second apparatus further comprises: means for in accordance with a determination that the second information indicates a second threshold delay that is the activation delay multiplying a second scaling factor, changing the activation delay of the at least one AI/ML entity to be the second threshold delay.

In some example embodiments, the second apparatus further comprises: means for in accordance with a determination that the second information indicates a third threshold delay that is the switching delay multiplying a third scaling factor, changing the switching delay of the at least one AI/ML entity to be the third threshold delay.

In some example embodiments, the second apparatus further comprises: means for in accordance with a determination that the second information indicates a fourth threshold delay that is the switching delay multiplying a fourth scaling factor, changing the switching delay of the at least one AI/ML entity to be the fourth threshold delay.

In some example embodiments, the second information indicates that the updated activation delay is out of range, or wherein the second information indicating no support of the at least one AI/ML entity.

In some example embodiments, the second information further comprises a metric obtained by the terminal device/ML entity.

In some example embodiments, the at least one AI/ML entity is related to one of: channel state information feedback of the terminal device, a beam management of the terminal device, or a positioning of the terminal device.

In some example embodiments, the apparatus comprises a network device.

In some example embodiments, the second apparatus further comprises means for performing other operations in some example embodiments of the method 500 or the second device 120. In some example embodiments, the means comprises at least one processor; and at least one memory storing instructions that, when executed by the at least one processor, cause the performance of the second apparatus.

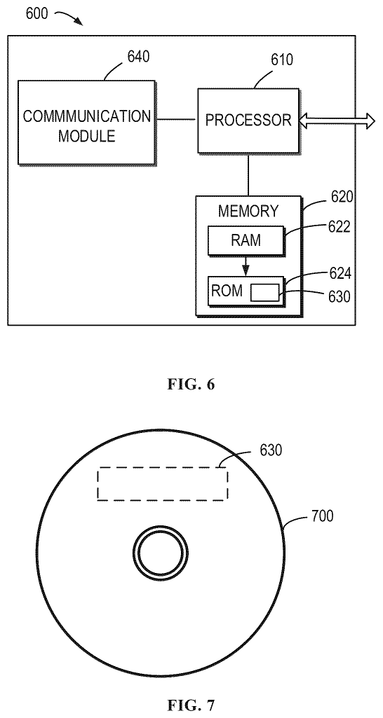

FIG. 6 is a simplified block diagram of a device 600 that is suitable for implementing example embodiments of the present disclosure. The device 600 may be provided to implement a communication device, for example, the first device 110 or the second device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624.

The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-29. (canceled)

30. An apparatus comprising:
at least one processor; and
at least one memory storing instructions that, when executed by the at least one processor, cause the apparatus to:
transmit, to a network device, first information indicating a first artificial intelligence and machine learning (AI/ML) entity supported by the apparatus and a first delay associated with the first AI/ML entity, wherein the first delay comprises a first activation delay of the first AI/ML entity and a first switching delay between another AI/ML entity and the first AI/ML entity;
in accordance with a determination that an indication to activate or switch to the first AI/ML entity is received from the network device, determine a first updated delay associated with the first AI/ML entity, wherein the first updated delay comprises a first updated activation delay of first AI/ML entity and a first updated switching delay between the other AI/ML entity and the first AI/ML entity;
determine whether there is a change between the first delay and the first updated delay based on a predefined criterion;
in accordance with a determination that the first updated activation delay is smaller than or equal to a first activation threshold delay and that the first updated switching delay is smaller than or equal to a first switching threshold delay, determine that there is a change between the first delay and the first updated delay based on the predefined criterion, wherein the first activation threshold delay is the first activation delay multiplying a first activation scaling factor, and wherein the first switching threshold delay is the first switching delay multiplying a first switching scaling factor;
based on the determination that the first updated activation delay is smaller than or equal to the first activation threshold delay and that the first updated switching delay is smaller than or equal to the first switching threshold delay, transmit, to the network device, the first updated activation delay and the first updated switching delay;
transmit, to a network device, second information indicating a second AI/ML entity supported by the apparatus and a second delay associated with the second AI/ML entity, wherein the second delay comprises a second activation delay of the second AI/ML entity and a second switching delay between another AI/ML entity and the second AI/ML entity;
in accordance with a determination that an indication to activate or switch to the second AI/ML entity is received from the network device, determine a second updated delay associated with the first AI/ML entity, wherein the second updated delay comprises a second updated activation delay of second AI/ML entity and a second updated switching delay between the other AI/ML entity and the second AI/ML entity;
determine whether there is a change between the second delay and the second updated delay based on a predefined criterion;
in accordance with a determination that the second updated activation delay is larger than a second activation threshold delay and that the second updated switching delay is larger than a second switching threshold delay, determine that the second updated activation delay and the second updated switching delay are out of range based on the predefined criterion, wherein the second activation threshold delay is the second activation delay multiplying a second activation scaling factor, and wherein the second switching threshold delay is the second switching delay multiplying a second switching scaling factor; and
based on the determination that the second updated activation delay is larger than the second activation threshold delay and that the second updated switching delay is larger than the second switching threshold delay, transmit, to the network device, third information indicating no support of the second AI/ML entity.

31. The apparatus of claim 30, wherein the apparatus is caused to:
transmit, to the network device, third information indicating a third AI/ML entity supported by the apparatus and a third delay associated with the third AI/ML entity, wherein the third delay comprises a third activation delay of the third AI/ML entity;
in accordance with a determination that an indication to activate the third AI/ML entity is received from the network device, determine a third updated delay associated with the third AI/ML entity, wherein the third updated delay comprises a third updated activation delay of third AI/ML entity;
determine whether there is a change between the third delay and the third updated delay based on a predefined criterion;
in accordance with a determination that the third updated activation delay is larger than a third threshold delay but smaller or equal to the third activation delay, determine that there is no change between the third delay and the third updated delay based on the predefined criterion, wherein the third threshold delay is the third activation delay multiplying a third scaling factor; and
transmit, to the network device, the third information indicating no change between the third delay and the third updated delay.

32. The apparatus of claim 31, wherein the apparatus is caused to:
transmit, to the network device, fourth information indicating a fourth AI/ML entity supported by the apparatus and a fourth delay associated with the fourth AI/ML entity, wherein the fourth delay comprises a fourth switching delay between another AI/ML entity and the fourth AI/ML entity;
in accordance with a determination that an indication to switch to the fourth AI/ML entity is received from the network device, determine a fourth updated delay associated with the fourth AI/ML entity, wherein the fourth updated delay comprises a fourth updated switching delay between another AI/ML entity and the fourth AI/ML entity;
determine whether there is a change between the fourth delay and the fourth updated delay based on a predefined criterion;
in accordance with a determination that the fourth updated switching delay is larger than a fourth threshold delay but smaller or equal to the fourth switching delay, determine there is no change between the fourth delay and the fourth updated delay based on the predefined criterion, wherein the fourth threshold delay is the fourth switching delay multiplying a fourth scaling factor; and
transmit, to the network device, the fourth information indicating no change between the fourth delay and the fourth updated delay.

33. The apparatus of claim 32, wherein the apparatus is caused to:
transmit, to the network device, fifth information indicating a fifth AI/ML entity supported by the apparatus and a fifth delay associated with the fifth AI/ML entity, wherein the fifth delay comprises a fifth switching delay between another AI/ML entity and the fifth AI/ML entity;
in accordance with a determination that an indication to switch to the fifth AI/ML entity is received from the network device, determine a fifth updated delay associated with the fifth AI/ML entity, wherein the fifth updated delay comprises a fifth updated switching delay between another AI/ML entity and the fifth AI/ML entity;
determine whether there is a change between the fifth delay and the fifth updated delay based on a predefined criterion;
in accordance with a determination that the fifth updated switching delay is larger than the fifth switching delay but smaller or equal to a fifth threshold delay, determine that there is the change between the fifth delay and the fifth updated delay based on the predefined criterion, wherein the fifth threshold delay is the fifth switching delay multiplying a fifth scaling factor; and
transmit, to the network device, the fifth information indicating the fifth threshold delay or the fifth updated switching delay.

34. The apparatus of claim 33, wherein the second information further comprises a metric result obtained by the apparatus.

35. The apparatus of claim 34, wherein the first, the second, the third, and the fourth AI/ML entities are related to channel state information feedback of the apparatus, a beam management of the apparatus, and a positioning of the apparatus.

36. The apparatus of claim 35, wherein the apparatus comprises a terminal device.

37. A system comprising:
an apparatus:
at least one processor; and
at least one memory storing instructions that, when executed by the at least one processor, cause the apparatus to:
transmit, to a network device, first information indicating a first artificial intelligence and machine learning (AI/ML) entity supported by the apparatus and a first delay associated with the first AI/ML entity, wherein the first delay comprises a first activation delay of the first AI/ML entity and a first switching delay between another AI/ML entity and the first AI/ML entity;
in accordance with a determination that an indication to activate or switch to the first AI/ML entity is received from the network device, determine a first updated delay associated with the first AI/ML entity, wherein the first updated delay comprises a first updated activation delay of first AI/ML entity and a first updated switching delay between the other AI/ML entity and the first AI/ML entity;
determine whether there is a change between the first delay and the first updated delay based on a predefined criterion;
in accordance with a determination that the first updated activation delay is smaller than or equal to a first activation threshold delay and that the first updated switching delay is smaller than or equal to a first switching threshold delay, determine that there is a change between the first delay and the first updated delay based on the predefined criterion, wherein the first activation threshold delay is the first activation delay multiplying a first activation scaling factor, and wherein the first switching threshold delay is the first switching delay multiplying a first switching scaling factor;
based on the determination that the first updated activation delay is smaller than or equal to the first activation threshold delay and that the first updated switching delay is smaller than or equal to the first switching threshold delay, transmit, to the network device, the first updated activation delay and the first updated switching delay;
transmit, to a network device, second information indicating a second AI/ML entity supported by the apparatus and a second delay associated with the second AI/ML entity, wherein the second delay comprises a second activation delay of the second AI/ML entity and a second switching delay between another AI/ML entity and the second AI/ML entity;
in accordance with a determination that an indication to activate or switch to the second AI/ML entity is received from the network device, determine a second updated delay associated with the first AI/ML entity, wherein the second updated delay comprises a second updated activation delay of second AI/ML entity and a second updated switching delay between the other AI/ML entity and the second AI/ML entity;
determine whether there is a change between the second delay and the second updated delay based on a predefined criterion;
in accordance with a determination that the second updated activation delay is larger than a second activation threshold delay and that the second updated switching delay is larger than a second switching threshold delay, determine that the second updated activation delay and the second updated switching delay are out of range based on the predefined criterion, wherein the second activation threshold delay is the second activation delay multiplying a second activation scaling factor, and wherein the second switching threshold delay is the second switching delay multiplying a second switching scaling factor; and
based on the determination that the second updated activation delay is larger than the second activation threshold delay and that the second updated switching delay is larger than the second switching threshold delay, transmit, to the network device, third information indicating no support of the second AI/ML entity.

38. The system of claim 37, wherein the apparatus is caused to:
transmit, to the network device, third information indicating a third AI/ML entity supported by the apparatus and a third delay associated with the third AI/ML entity, wherein the third delay comprises a third activation delay of the third AI/ML entity;
in accordance with a determination that an indication to activate the third AI/ML entity is received from the network device, determine a third updated delay associated with the third AI/ML entity, wherein the third updated delay comprises a third updated activation delay of third AI/ML entity;
determine whether there is a change between the third delay and the third updated delay based on a predefined criterion;
in accordance with a determination that the third updated activation delay is larger than a third threshold delay but smaller or equal to the third activation delay, determine that there is no change between the third delay and the third updated delay based on the predefined criterion, wherein the third threshold delay is the third activation delay multiplying a third scaling factor; and
transmit, to the network device, the third information indicating no change between the third delay and the third updated delay.

39. The system of claim 38, wherein the apparatus is caused to:
transmit, to the network device, fourth information indicating a fourth AI/ML entity supported by the apparatus and a fourth delay associated with the fourth AI/ML entity, wherein the fourth delay comprises a fourth switching delay between another AI/ML entity and the fourth AI/ML entity;
in accordance with a determination that an indication to switch to the fourth AI/ML entity is received from the network device, determine a fourth updated delay associated with the fourth AI/ML entity, wherein the fourth updated delay comprises a fourth updated switching delay between another AI/ML entity and the fourth AI/ML entity;
determine whether there is a change between the fourth delay and the fourth updated delay based on a predefined criterion;
in accordance with a determination that the fourth updated switching delay is larger than a fourth threshold delay but smaller or equal to the fourth switching delay, determine there is no change between the fourth delay and the fourth updated delay based on the predefined criterion, wherein the fourth threshold delay is the fourth switching delay multiplying a fourth scaling factor; and
transmit, to the network device, the fourth information indicating no change between the fourth delay and the fourth updated delay.

40. The system of claim 39, wherein the apparatus is caused to:
transmit, to the network device, fifth information indicating a fifth AI/ML entity supported by the apparatus and a fifth delay associated with the fifth AI/ML entity, wherein the fifth delay comprises a fifth switching delay between another AI/ML entity and the fifth AI/ML entity;
in accordance with a determination that an indication to switch to the fifth AI/ML entity is received from the network device, determine a fifth updated delay associated with the fifth AI/ML entity, wherein the fifth updated delay comprises a fifth updated switching delay between another AI/ML entity and the fifth AI/ML entity;
determine whether there is a change between the fifth delay and the fifth updated delay based on a predefined criterion;
in accordance with a determination that the fifth updated switching delay is larger than the fifth switching delay but smaller or equal to a fifth threshold delay, determine that there is the change between the fifth delay and the fifth updated delay based on the predefined criterion, wherein the fifth threshold delay is the fifth switching delay multiplying a fifth scaling factor; and
transmit, to the network device, the fifth information indicating the fifth threshold delay or the fifth updated switching delay.

41. The system of claim 40, wherein the second information further comprises a metric result obtained by the apparatus.

42. The system of claim 41, wherein the first, second, third, and fourth AI/ML entities are related to channel state information feedback of the apparatus, a beam management of the apparatus, and a positioning of the apparatus.

43. The system of claim 42, wherein the apparatus comprises a terminal device.

44. A method comprising:
transmitting, to a network device, first information indicating a first artificial intelligence and machine learning (AI/ML) entity supported by the apparatus and a first delay associated with the first AI/ML entity, wherein the first delay comprises a first activation delay of the first AI/ML entity and a first switching delay between another AI/ML entity and the first AI/ML entity;
in accordance with a determination that an indication to activate or switch to the first AI/ML entity is received from the network device, determining a first updated delay associated with the first AI/ML entity, wherein the first updated delay comprises a first updated activation delay of first AI/ML entity and a first updated switching delay between the other AI/ML entity and the first AI/ML entity;
determining whether there is a change between the first delay and the first updated delay based on a predefined criterion;
in accordance with a determination that the first updated activation delay is smaller than or equal to a first activation threshold delay and that the first updated switching delay is smaller than or equal to a first switching threshold delay, determining that there is a change between the first delay and the first updated delay based on the predefined criterion, wherein the first activation threshold delay is the first activation delay multiplying a first activation scaling factor, and wherein the first switching threshold delay is the first switching delay multiplying a first switching scaling factor;
based on the determination that the first updated activation delay is smaller than or equal to the first activation threshold delay and that the first updated switching delay is smaller than or equal to the first switching threshold delay, transmitting, to the network device, the first updated activation delay and the first updated switching delay;
transmitting, to a network device, second information indicating a second AI/ML entity supported by the apparatus and a second delay associated with the second AI/ML entity, wherein the second delay comprises a second activation delay of the second AI/ML entity and a second switching delay between another AI/ML entity and the second AI/ML entity;
in accordance with a determination that an indication to activate or switch to the second AI/ML entity is received from the network device, determining a second updated delay associated with the first AI/ML entity, wherein the second updated delay comprises a second updated activation delay of second AI/ML entity and a second updated switching delay between the other AI/ML entity and the second AI/ML entity;
determining whether there is a change between the second delay and the second updated delay based on a predefined criterion;
in accordance with a determination that the second updated activation delay is larger than a second activation threshold delay and that the second updated switching delay is larger than a second switching threshold delay, determining that the second updated activation delay and the second updated switching delay are out of range based on the predefined criterion, wherein the second activation threshold delay is the second activation delay multiplying a second activation scaling factor, and wherein the second switching threshold delay is the second switching delay multiplying a second switching scaling factor; and
based on the determination that the second updated activation delay is larger than the second activation threshold delay and that the second updated switching delay is larger than the second switching threshold delay, transmitting, to the network device, third information indicating no support of the second AI/ML entity.

45. The method of claim 44, further comprising:
transmitting, to the network device, third information indicating a third AI/ML entity supported by the apparatus and a third delay associated with the third AI/ML entity, wherein the third delay comprises a third activation delay of the third AI/ML entity;
in accordance with a determination that an indication to activate the third AI/ML entity is received from the network device, determining a third updated delay associated with the third AI/ML entity, wherein the third updated delay comprises a third updated activation delay of third AI/ML entity;
determining whether there is a change between the third delay and the third updated delay based on a predefined criterion;
in accordance with a determination that the third updated activation delay is larger than a third threshold delay but smaller or equal to the third activation delay, determining that there is no change between the third delay and the third updated delay based on the predefined criterion, wherein the third threshold delay is the third activation delay multiplying a third scaling factor; and
transmitting, to the network device, the third information indicating no change between the third delay and the third updated delay.

46. The method of claim 45, further comprising:
transmitting, to the network device, fourth information indicating a fourth AI/ML entity supported by the apparatus and a fourth delay associated with the fourth AI/ML entity, wherein the fourth delay comprises a fourth switching delay between another AI/ML entity and the fourth AI/ML entity;
in accordance with a determination that an indication to switch to the fourth AI/ML entity is received from the network device, determining a fourth updated delay associated with the fourth AI/ML entity, wherein the fourth updated delay comprises a fourth updated switching delay between another AI/ML entity and the fourth AI/ML entity;
determining whether there is a change between the fourth delay and the fourth updated delay based on a predefined criterion;
in accordance with a determination that the fourth updated switching delay is larger than a fourth threshold delay but smaller or equal to the fourth switching delay, determining there is no change between the fourth delay and the fourth updated delay based on the predefined criterion, wherein the fourth threshold delay is the fourth switching delay multiplying a fourth scaling factor; and
transmitt9jg, to the network device, the fourth information indicating no change between the fourth delay and the fourth updated delay.

47. The method of claim 46, further comprising:
transmitting, to the network device, fifth information indicating a fifth AI/ML entity supported by the apparatus and a fifth delay associated with the fifth AI/ML entity, wherein the fifth delay comprises a fifth switching delay between another AI/ML entity and the fifth AI/ML entity;
in accordance with a determination that an indication to switch to the fifth AI/ML entity is received from the network device, determining a fifth updated delay associated with the fifth AI/ML entity, wherein the fifth updated delay comprises a fifth updated switching delay between another AI/ML entity and the fifth AI/ML entity;
determining whether there is a change between the fifth delay and the fifth updated delay based on a predefined criterion;
in accordance with a determination that the fifth updated switching delay is larger than the fifth switching delay but smaller or equal to a fifth threshold delay, determining that there is the change between the fifth delay and the fifth updated delay based on the predefined criterion, wherein the fifth threshold delay is the fifth switching delay multiplying a fifth scaling factor; and
transmitting, to the network device, the fifth information indicating the fifth threshold delay or the fifth updated switching delay.

48. The method of claim 47, wherein the second information further comprises a metric result obtained by the apparatus.

49. The method of claim 48, wherein the first, second, third, and fourth AI/ML entities are related to channel state information feedback of the apparatus, a beam management of the apparatus, and a positioning of the apparatus.
